(19) United States
(12) Patent Application Publication
(10) Pub. No.: US 2011/0034213 A1
(43) Pub. Date: Feb. 10, 2011

(54) PORTABLE COMMUNICATION DEVICE WITH LATERAL SCREEN POSITIONING

(76) Inventor: Vladimir Vitalievich Miroshnichenko, Moscow region (RU)

Correspondence Address: Aleksandr Smushkovich, POB 140505, Brooklyn, NY, 11214, US

(21) Appl. No.: 12/736,370

(22) PCT Filed: Apr. 3, 2010
(86) PCT No.: PCT/RU2009/000160

§ 371 Date: Oct. 1, 2010

(30) Foreign Application Priority Data
Apr. 10, 2008 (RU) 2008113634

(51) Int. Cl. G06F 3/02

(52) U.S. Cl. 455/566

(57) ABSTRACT

The mutual arrangement of a display screen and a keyboard proposed herein can be used in mobile phones, smartphone, communicators, or similar portable devices. The keyboard, having push buttons, sensors, etc. is based on the body of a portable communication device, and initially disposed partially or fully under the sliding screen of the device. The keyboard is partially overlapped or fully covered by the sliding screen. When using the keyboard or its part, which is hidden under the sliding screen, the screen is moved to the lateral side, while the symbols on the keyboard are arranged vertically (vertical layout of the keyboard) relatively to the body of the device. Optionally, the vertical layout can be altered to the horizontal layout, and, during such alteration, the buttons' functions can be changed as well.

### CROSS-REFERENCE TO RELATED APPLICATIONS

This application is a U.S. national stage application of a PCT application PCT/RU2009/000160 filed on 3 Apr. 2009, whose disclosure is incorporated herein in its entirety by reference, which PCT application claims priority of a Russian Federation application RU2008113634 filed on 10 Apr. 2008. The PCT application also contains parts of disclosure absent in RU2008113634, for which parts the priority of PCT/RU2009/000160 is claimed for this U.S. national stage application.

### FIELD OF THE INVENTION

The present invention relates to methods and devices for positioning an information output (display) screen (herein further called ‘screen’) relatively to a data input (entry) keyboard (herein further called ‘keyboard’) in mobile telephones, smart-phones, communicators, or similar portable communication devices (herein also collectively called a ‘portable communication device’, or simply ‘device’).

### BACKGROUND OF THE INVENTION

In modern mobile phones, smart-phones, and communicators, having a screen and a keyboard, there are known three basic types of arrangement (positioning) of the screen relatively to the keyboard.

In the first type of arrangement, the keyboard is positioned below the screen.

In the second type of arrangement, the keyboard is positioned above the screen.

In the third type of arrangement, the keyboard is displayed on the screen (also known as a ‘touch’ or ‘sensor’ screen). The third type of arrangement is mainly used in smart-phones and communicators.

A disadvantage of the first type of arrangement is that a user's fingers excessively bend when the user enters data using buttons of the keyboard; the screen can move beyond the area of the user's palm, which often causes the device to fall down due to the user's occasional movements and/or accidental impacts. When the keyboard and the screen are situated horizontally (as shown on FIG. 1), the user may experience a difficulty entering keyboard symbols with one hand, while the portable communication device is supported by the second hand only.

A disadvantage of the second type of arrangement is that while entering symbols on the keyboard, the user's hand partially overlaps the screen, making it difficult to read screen information.

The closest prior art analogues of the invention are described in EP1898605, WO2006072657, RU62758, and US2006046796, in which the data entering keyboard is located fully under the screen.

### OBJECT AND BRIEF DESCRIPTION OF THE INVENTION

A primary object of this invention is to propose another type of arrangement of the screen relatively to the keyboard, herein called a ‘lateral screen positioning’ in the aforesaid portable communication devices. An inventive device of this type of arrangement is designed for improvement of keyboard data entering as well as for improvement of screen information display, wherein the keyboard is provided with a vertical layout of symbols. Other objects of the invention can be discovered and attained by those skilled in the art upon learning the present disclosure.

In a main embodiment of the present invention, a portable communication device comprises:—a body;—a keyboard associated with the body;—a display screen movably associated with the body; the screen is initially set in an initial position, wherein the screen partially overlaps or fully covers the keyboard, and the screen can be operatively moved in a predetermined lateral position, wherein the screen fully uncovers the keyboard; and wherein the keyboard has a vertical layout of symbols.

In other embodiments, the device is characterized in that the keyboard has an upper keyboard side; the screen has an upper screen side; and—either: the upper screen side and the upper keyboard side are located at the same level in the predetermined lateral position of the screen;—or: the upper screen side is located at a level above a corresponding level of the upper keyboard side in the predetermined lateral position of the screen.

In other embodiments, the device is characterized in that the vertical layout of symbols is changed to a horizontal layout of symbols.

In other embodiments, the device is characterized in that the function of any button of the keyboard is changed upon changing the vertical layout of symbols to the horizontal layout of symbols.

Yet, in other embodiments, the device comprises:—a display screen of a sensor type;—a keyboard built into the screen; the keyboard includes a plurality of buttons, each of the buttons corresponds to a predetermined symbol or a predetermined function; the buttons are displayed on the screen in the form of virtual icons; the virtual icons each is initially associated with and displayed in a predetermined sector of the keyboard; wherein the keyboard has an initial vertical layout of symbols, the initial vertical layout of symbols can be operatively altered to a horizontal layout of symbols; and during the altering of the layout of symbols, each of the buttons is associated with and displayed in a different predetermined sector of the keyboard.

### BRIEF DESCRIPTION OF DRAWINGS OF THE INVENTION

FIG. 1 schematically shows an exemplary design of the keyboard with a horizontal layout of symbols (letters, numbers, and other symbols).

FIG. 2 schematically shows an exemplary design of the keyboard with a vertical layout of symbols.

FIG. 3 schematically shows a portable communication device with a lateral screen positioning, according to an embodiment of the present invention. Herein, a reference numeral (1) denotes a keyboard with a vertical layout of symbols, having a size (B), shown for the time of entering the symbols by the user; and a reference numeral (2) denotes a screen, having a size (A), which size (A) can be expanded to the size (B).

FIG. 4 schematically shows a portable communication device with the lateral screen positioning, according to an embodiment of the present invention. Herein the screen is situated at the lateral side and above the body of the portable communication device, wherein the reference numeral (1) denotes the keyboard with the vertical layout of symbols, and the reference numeral (2) denotes the screen.

### DETAIL DESCRIPTION OF PREFERRED EMBODIMENTS OF THE INVENTION

While the invention may be susceptible to embodiment in different forms, there are described in detail herein below, specific embodiments of the present invention, with the understanding that the present disclosure is to be considered an exemplification of the principles of the invention, and is not intended to limit the invention to that as illustrated and described herein.

The above-mentioned disadvantages can be eliminated to a large extent by the lateral screen positioning described in the present application (depicted on FIG. 3). The essence of the lateral screen positioning lies in the fact that the keyboard (push button, sensor, etc.) based on the body of a portable communication device is disposed under a sliding screen of the device partially or fully, that is partially overlapped or fully covered by the sliding screen. If the user wants to use the part or the entire keyboard, which is hidden under the sliding screen, the sliding screen moves to the lateral side, wherein the symbols on the keyboard are arranged vertically (the vertical layout of the keyboard) relatively to the body of the device (shown on FIG. 2).

When the user moves the screen to the lateral side, the screen is not separated from the body of the device. In this case, unlike in the first type of arrangement, the user's fingers do not significantly bend, because the keyboard is not situated below the screen, but is situated at the lateral side of the screen.

In contrast to the second type of arrangement, the user's fingers do not overlap the screen while entering the symbols on the keyboard, because the screen is positioned at the lateral side of the keyboard during the entering of symbols. The screen, while being in the lateral position in relation to the device body, may also be in a position, herein defined as an upper lateral position that is located at a lateral side and partially above the device body (illustrated on FIG. 4).

The vertical layout of the keyboard allows entering symbols with one hand without supporting the device with the second hand. The screen, shifted to the lateral side, allows placing the keyboard or its part under the screen on the device's body. When the screen is moved to the lateral side, there is an opportunity to use the keyboard or its part located under the screen.

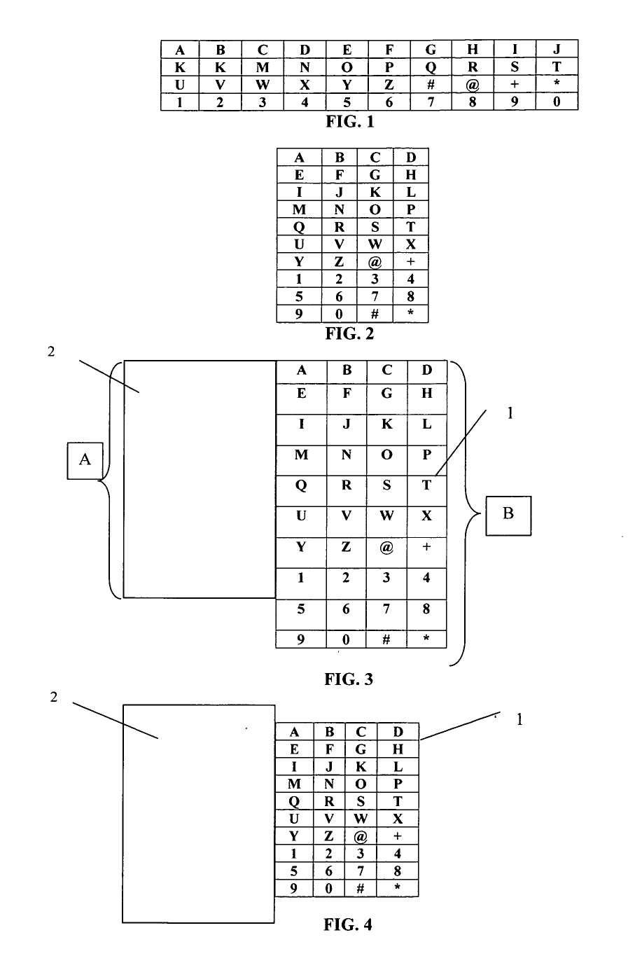

The difference between a keyboard with the vertical layout of symbols (shown on FIG. 2) and a keyboard with the horizontal layout of symbols (shown on FIG. 1) lies in the fact that, in the vertical layout of symbols, the number of keyboard buttons or sectors (for the touch keyboard) in a horizontal row is fewer than their number in a vertical row. The ways of moving the screen to the lateral side can be different and are not a subject of this invention.

If the keyboard is built in a touch screen and the keyboard's symbols are displayed thereon as virtual icons, there is an option of changing the vertical keyboard layout to the horizontal one, for example, when the device is placed on a table. A virtual symbol associated with and displayed in a certain sector of the touch (sensor) screen keyboard of the vertical layout type, during the altering of the layout from the vertical to the horizontal type, can be associated with another sector and displayed therein respectively.

If the keyboard is a set of buttons, the buttons may be marked with symbols, e.g. letters and numbers (and/or the symbols may be placed near the buttons), wherein the buttons can be marked differently for the vertical and the horizontal layouts. The layouts can be altered from one to the other, e.g. when the device is placed on a table.

In such embodiments, the markings and functions of the buttons can differ depending on the layout, e.g. in the vertical layout a button has a function of entering the letter “A”, while in the horizontal layout of the keyboard the same button has a function of entering the number “1”, etc.

### APPLICATIONS OF THE INVENTION

The implementation of this invention is possible with the deployment of known technologies and technical solutions for portable communication devices having a keyboard and a screen, but with the use of the novel arrangement of the screen relatively to the keyboard, which allows moving the screen to the lateral side of the device. The ways of moving the screen can be different, and are not a subject of this invention.

1. A portable communication device comprising:
a body;
a keyboard associated with said body; and
a display screen movably associated with said body; and
said screen is initially set in an initial position, wherein said screen partially overlaps or fully covers said keyboard, said screen is operatively moved in a predetermined lateral position,
wherein said screen fully uncovers said keyboard; and
wherein said keyboard has a vertical layout of symbols.

2. The portable communication device according to claim 1, wherein
said keyboard has an upper keyboard side; said screen has an upper screen side; and —either:
said predetermined lateral position of the screen is characterized in that the upper screen side and the upper keyboard side are located at the same level; —or:
said predetermined lateral position of the screen is characterized in that the upper screen side is located at a level above a corresponding level of the upper keyboard side.

3. The portable communication device according to claim 1, wherein
said vertical layout of symbols is changed to a horizontal layout of symbols.

4. The portable communication device according to claim 2, wherein
said vertical layout of symbols is changed to a horizontal layout of symbols.

5. The portable communication device according to claim 4, wherein:
said keyboard further includes a plurality of buttons, each said button corresponds to a predetermined symbol or a predetermined function, and
wherein the predetermined symbol or function of any said button is changed upon changing said vertical layout of symbols to said horizontal layout of symbols.

6. The portable communication device according to claim 3, wherein:
said keyboard further includes a plurality of buttons, each said button corresponds to a predetermined symbol or a predetermined function, and
wherein the predetermined symbol or function of any said button is changed upon changing said vertical layout of symbols to said horizontal layout of symbols.

7. A portable communication device comprising:
a display screen of a sensor type;
a keyboard built into said screen; said keyboard includes a plurality of buttons, each said button corresponds to a predetermined symbol or a predetermined function; said buttons are displayed on said screen in the form of virtual icons; said virtual icons each is initially associated with and displayed in a predetermined sector of said keyboard; wherein
said keyboard has an initial vertical layout of symbols, said initial vertical layout of symbols can be altered to a horizontal layout of symbols; and
during the altering of the layout of symbols, each said button is associated with and displayed in a different predetermined sector of said keyboard.
